(19) United States
(12) Patent Application Publication
(10) Pub. No.: US 2012/0322528 A1
(43) Pub. Date: Dec. 20, 2012

(54) METHOD AND APPARATUS FOR PLAYING LOTTERY AND CHECKING LOTTERY TICKETS

(76) Inventor: Dipak Sheth, Greenwich, CT (US)

(21) Appl. No.: 13/160,520

(22) Filed: Jun. 15, 2011

(51) Int. Cl. A63F 9/24; G06F 19/00

(52) U.S. Cl. 463/17; 700/91

(57) ABSTRACT

A method and apparatus for playing a lottery and checking lottery tickets to determine that they are winning or losing tickets is provided. This method provides an effective technique for players to store and play their favorite numbers, to check the status of their lottery tickets in a direct and convenient way, and to keep record of winning and losing tickets. The method for checking winning lottery tickets may comprise receiving a user request to check a winning lottery ticket, with the user request comprising a ticket number, verifying the lottery ticket number with a lottery managing system to determine whether the lottery ticket is the winning lottery ticket, and providing the lottery results to the user. The method may further comprise determining user location and providing nearby lottery dealer information based on the determined user location. The method may further comprise storing and recalling favorite numbers and keeping records of the winning and losing tickets of the user.

### TECHNICAL FIELD

This disclosure relates generally to electronic arrangements for playing lottery and checking lottery tickets and, more specifically, to a method and apparatus for playing lottery and checking lottery tickets via a portable electronic device.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Every day millions of people play lotteries hoping to obtain a cash prize. In traditional lotteries, players walk into convenience stores, manually fill out selection slips, and pay a clerk with cash or credit. Many states have banned credit cards as a means of paying to play lottery. The clerk then enters the selections into a lottery terminal. This lottery terminal connects electronically to a lottery managing system operating the lottery games. The lottery managing system then issues a coded lottery ticket, and the coded lottery ticket is delivered to the players through the local lottery terminal at the lottery dealer.

Checking the winning numbers and comparing them to the each of the purchased tickets requires considerable effort. A vast majority of players purchase lottery tickets but fail to check whether they have the winning numbers, since it may require a special trip to the lottery dealer store. Checking the winning numbers on the Internet or watching them as they are drawn on TV broadcast also requires persistence and discipline. As a result, many winning tickets are not claimed by winners due to the lack of knowledge that they are holding a winning ticket.

There have also been many instances of lottery clerks defrauding winners by replacing winning tickets handed to the clerk for verification by the lottery customer.

Many customers play the same set of numbers on regular basis. Remembering and playing them is always a tedious matter. Repeatedly having to fill out the play slips consumes time and is not the task that many players enjoy.

### SUMMARY

This summary is provided to introduce a selection of concepts, in a simplified form, that are further described below in the Detailed Description. This summary is not intended to identify key features or essential features of the claimed subject matter, nor is it intended to be used as an aid in determining the scope of the claimed subject matter.

In accordance with various embodiments and the corresponding disclosure thereof, a method for checking lottery tickets to determine whether they won or lost, and to aid the user in playing their favorite numbers via manual or automated manner is provided. This method provides an effective technique for players to check the status of their tickets in a direct and convenient way without the necessity to browse the Internet, watch TV, check newspaper, check winning numbers result slip or check a lottery terminal located in a dealer store; and to enter, download, store, retrieve, upload and print user's favorite numbers. The method also minimizes instances of fraud by the dealers' staffs.

In one embodiment, a computer-implemented method for checking winning lottery tickets is provided. The method may comprise receiving a user request, manual or automated, to check a winning lottery ticket, wherein the user request may comprise a ticket number; verifying the lottery ticket number with a lottery managing system to determine whether the lottery ticket is a winning lottery ticket, and providing the lottery results to the user.

In another embodiment, a computer-implemented method for playing lottery is provided. The method may comprise a system allowing the user to enter, download and store user's favorite lottery numbers. The method may further comprise a system allowing the user to retrieve the stored numbers and to upload, print or electronically send them to be played by the dealer or the lottery management system of user's choice.

The method may further comprise determining user location and providing information of nearby lottery dealers based on the determined location. The method may further comprise retrieving user credentials, with the user credentials being used for accessing a lottery checking system. The lottery results may comprise one or more of the following: information as to whether the lottery ticket is a wining ticket or a losing ticket, winning numbers, a payoff amount, and claim filing procedure, lottery dealers' locations, claim centers, and a claim deadline. The method may further comprise receiving a user selection to retrieve the results of a desired lottery. The method may further comprise providing the user with the results of the selected lottery.

In one example, if the lottery ticket is a winning lottery ticket, the lottery results may comprise the payoff amount, and the method may further comprise providing the user with information related to the payoff amount, claim procedure and information related to nearby claim centers (based on the user location). The method may further comprise storing the payoff amount and cost associated with one or more lottery tickets of the user in a database. The method may further comprise storing the cost associated with one or more non-winning lottery tickets of the user in a database. The method may further comprise storing one or more lottery tickets in the database, the lottery tickets being associated with the user, and automatically verifying the stored lottery tickets with the lottery managing system to determine whether or not the lottery tickets are winning lottery tickets. The method may also comprise keeping account of all winning as well as losing lottery tickets. The user's manual or automated request to check the winning lottery ticket may comprise game numbers selected by the user or unique ticket barcode of the purchased ticket. The step of verifying the lottery ticket with the lottery managing system to determine whether the lottery ticket is a winning lottery ticket may be based on the selected numbers or unique bar code/serial number issued by the lottery issuing authority to each lottery ticket.

According to yet another embodiment, an apparatus for checking winning lottery tickets is provided. The apparatus may comprise at least one processor configured to receive a user request to check a winning lottery ticket, with the user request comprising a ticket number/bar code, verify the lottery ticket number with a lottery managing system to determine whether the lottery ticket is a winning lottery ticket, and provide the lottery results to the user. The apparatus may also comprise a memory coupled to the at least one processor, with the memory comprising codes for the at least one processor.

The at least one processor may further be configured to determine user location and provide information regarding nearby lottery dealers based on the determined location. The at least one processor may further be configured to retrieve user credentials, with the user credentials being used for accessing a lottery checking system. The lottery results may comprise one or more of the following: information as to whether the lottery ticket is a wining ticket or a losing ticket, winning numbers, a payoff amount, lottery dealers, claim procedure, claim centers, and a claim deadline. The at least one processor may be further configured to receive a user selection to retrieve the results of a desired lottery. The at least one processor may further be configured to provide the user with the results of the selected lottery.

In one example, if the lottery ticket is a winning lottery ticket, the lottery results may comprise the payoff amount, and the at least one processor may be further configured to provide the user with information of the payoff amount and information regarding nearby claim centers (based on the user location). The at least one processor may further be configured to store the payoff amount associated with one or more lottery tickets of the user in a database. The at least one processor may further be configured to store one or more lottery tickets in the database, with the lottery tickets being associated with the user, and automatically verify the stored lottery tickets with the lottery managing system to determine whether or not the lottery tickets are winning lottery tickets. The at least one processor may further be configured to store one or more lottery tickets in the database, with all winning and losing lottery tickets being associated with the user, and automatically keep record of the winning and losing amounts to determine cumulative total of winnings and loses.

In yet another embodiment, a computer-readable medium having instructions stored thereon is provided. The instructions, when executed by one or more computers, cause the one or more computers to receive a user request to check a winning lottery ticket, with the user request comprising a ticket number, verify the lottery ticket number with a lottery managing system to determine whether the lottery ticket is a winning lottery ticket; and provide the lottery results to the user.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram illustrating a system environment suitable for checking lottery tickets, according to an example embodiment.

FIG. 2 is a diagram of a lottery checking system, according to an example embodiment.

FIG. 3 illustrates a method for delivering lottery results to a user, according to an example embodiment.

FIG. 4 illustrates a method for checking a lottery ticket, according to an example embodiment.

FIG. 5 illustrates a method for checking a lottery ticket, according to another example embodiment.

FIGS. 6A and 6B illustrate a graphical user interface displayed within a client device, according to two example embodiments.

FIG. 7 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein can be implemented by various means, depending on application. For example, the embodiments can be implemented in hardware, firmware, software, or a combination thereof. For a hardware implementation, the embodiments can be implemented with processors, controllers, micro-controllers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For a firmware and/or software implementation, the embodiments can be implemented with modules, such as procedures, functions, and so on, that perform the functions described herein. Any machine-readable medium tangibly embodying instructions can be used in implementing the embodiments described herein.

The embodiments disclosed herein relate to a method for checking lottery tickets as to whether or not they are winning tickets and method for playing favorite numbers. The term “lottery” is used herein to refer to various forms of gambling which involve the drawing of lots for a prize. One particular example of the lottery is a number game. In the number game, such as a “lotto 6/49,” a player chooses six numbers from 1 to 49 (no duplicates are allowed). If all six numbers on the player's ticket match those produced in the official drawing, then the player is a jackpot winner. Typically, lesser prizes are also awarded to players when fewer than 6 of the selected numbers are matched. In terms of this document, different designs of lotteries are applicable.

The number games are usually operated by a governmental entity, such as a country, county, state, province or multi-state lottery association. For this purpose, a lottery managing system is used that can be accessed via the Internet to issue lottery tickets in response to the purchase and selection of numbers by the player.

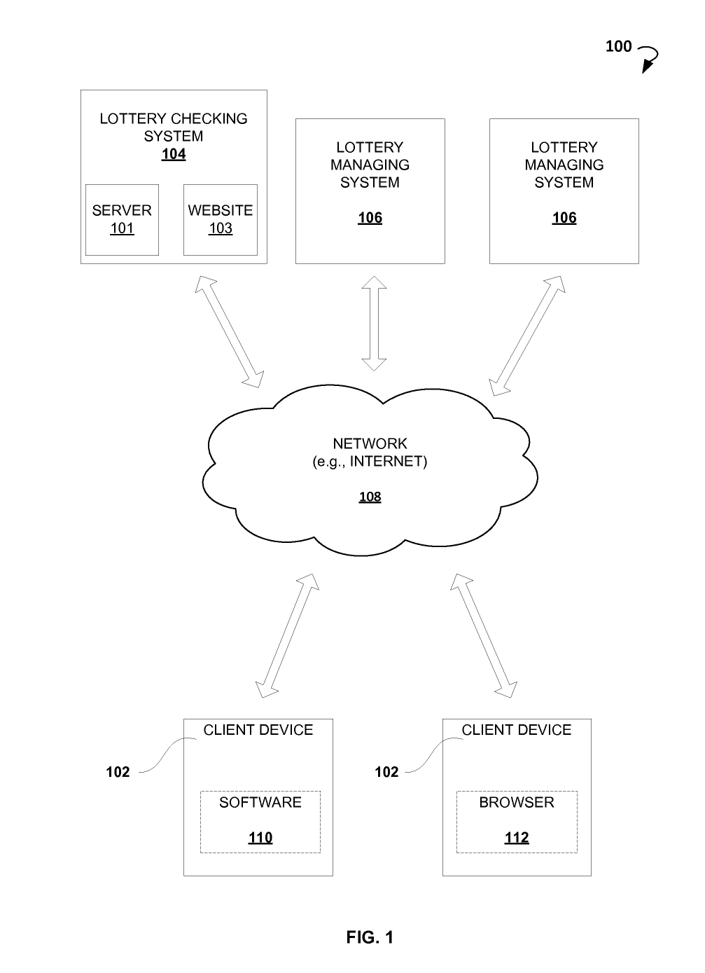

Referring now to the drawings, FIG. 1 is a block diagram illustrating a system environment 100 suitable for checking lottery tickets, according to an example embodiment. The system environment 100 comprises one or more client devices 102, a lottery checking system 104, one or more lottery managing systems 106, and a network 108. The network 108, such as the Internet, may couple the above-mentioned modules.

As used herein, the term “client device” may refer to a computer, a laptop, a tablet computer, a portable computing device, a personal digital assistant (PDA), a handheld cellular phone, a mobile phone, a smart phone, a cordless telephone, a handheld device having wireless connection capability, or any other electronic device with the ability to receive and transmit data via a cord or cordless network (e.g., with the ability to browse the Internet).

In one embodiment, the client devices 102 comprise software 110 to communicate with the lottery checking system 104. One particular example of the software 110 is a mobile application. In some other embodiments, the client devices 102 may comprise a browser 112 that provides the ability to browse and interact with websites on the Internet.

In addition, according to some embodiments, the client devices 102 may comprise a navigation system, such as a receiver of the Global Positioning System (GPS), and corresponding software that allows a user of the client device 102 to determine its current location, display maps, navigate, find a certain address, get directions and routes, and so forth.

The implementation described below includes a client-server environment. Thus, the lottery checking system 104 may comprise a server 101 and a website 103, which is a client of the server 101. The Internet is one example of a client-server environment. However, any other appropriate type of the client-server environment, such as an intranet, a wireless network, a telephone network, a peer-to-peer network, and so forth, may be used instead of or in addition to the Internet.

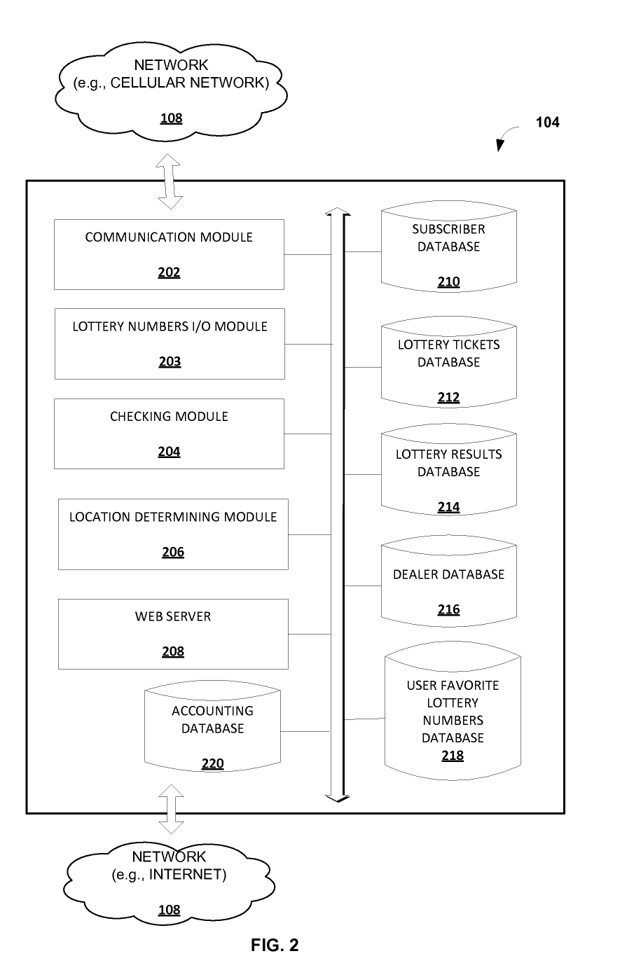

FIG. 2 is a diagram of the lottery checking system 104, according to an example embodiment. The lottery checking system 104 can be implemented as hardware having software installed thereon that implements the steps necessary for checking lottery tickets as discussed herein. In the shown embodiment, the lottery checking system 104 may include a communication module 202, a lottery numbers I/O module 203, a checking module 204, a location determining module 206, a web server 208, a subscriber database 210, a lottery tickets database 212, a lottery results database 214, a dealers database 216, a user favorite lottery numbers database 218, and accounting database 220. In other embodiments, the lottery checking system 104 may include additional, fewer, or different modules for various applications.

The communication module 202 may be used to connect the lottery checking system 104 to one or more client devices 102 and one or more lottery managing systems 106 via the network 108. The connection may be provided via an API interface, for example. In some embodiments, the connection can be accomplished via different networks 108. For example, the lottery managing systems 106 can be accessed via the Internet, while the client devices 102 can be accessed via a cellular network.

The lottery numbers I/O module 203 may be used to input/output user's favorite numbers and facilitate storing the favoring number in the user favorite lottery numbers database 218.

The communication with the lottery checking system 104 can optionally be performed via the web server 208. The web server 208 may host a website directed to management of user participation in lottery games, management of user accounts, tracking user actions, providing information related to lottery operations, and so forth.

The communication module 202 or the web server 208 may also be configured to transmit information from the one or more lottery managing systems 106 to one or more users.

Pursuant to the example embodiment, the checking module 204 facilitates the processing of user lottery tickets and determining whether they are winning or losing tickets, delivering lottery results to the users, storing the results in the lottery results database 214, and so forth. More specifically, the checking module 204 is configured to receive and process a user request to check a lottery ticket. In one example, the user request may comprise the inquiry to provide lottery results (e.g., wining numbers) of a specific lottery on a specific drawing day. If this is the case, the checking module 204 may address the lottery results database 214 to retrieve the requested information and deliver it to the user via the communication module 202 or the web server 208. If the lottery results are absent in the lottery results database 214, the checking module 204 may address the corresponding lottery managing system 106 to retrieve the requested information.

According to another example, the user request may comprise the inquiry to check a specific lottery ticket and determine whether or not it is a winning or losing ticket. If this is the case, the user request would comprise a ticket number or a combination of selected numbers. The checking module 204 then queries the corresponding lottery managing system 106 to verify the ticket number or retrieve the winning numbers and compare them with the inputted numbers. The result of the comparison is then delivered to the user via the communication module 202 or the web server 208.

The subscriber database 210 may store user related information, such as user accounts (names, logins, passwords, and so forth). The lottery tickets database 212 stores lottery ticket numbers associated with the user accounts, or stores numbers selected by the user to participate in a corresponding lottery. The lottery results database 214 may store results of different lotteries, and further lottery related information, such as payoff amounts, claim periods, and so forth. The lottery dealer database 216 may store addresses and contact information of lottery dealers, claim centers, and so forth.

The accounting database 220 may facilitate accounting of winning and losing tickets of a user. Besides storing the records of winning and losing tickets the accounting database 220 may store amounts associated with the winning tickets and provided year-end statements for tax purposes.

The users may register and establish personal accounts (profiles) in the subscriber database 210. The personal accounts may include information, such as a name, a date of birth, an address, contact information, lottery ticket numbers purchased, numbers selected for a particular lottery, records of lottery winning and loses, and so forth. The users may access the subscriber database 210 via the web server 208 or the communication module 202 to review, modify or delete information stored therein.

The checking module 204 may also be configured to manage the user accounts. In one example, the checking module 204 may automatically check whether the ticket numbers stored in the lottery tickets database 212 are winning or losing tickets, whether the numbers associated with a lottery stored in the lottery tickets database 212 are winning or losing, what amount of payoff is won, claim periods, and the like. If the ticket number (or number associated with a lottery) is a winning one, the user may be prompted via the communication module 202 or the web server 208 in the form of an instant message, a SMS/MMS, an e-mail, and so forth.

In addition, the checking module 204 may be configured to store lottery results in the lottery results database 214. The lottery results database 214 may be accessed anytime by users to check lottery tickets that have been stored in the lottery ticket database 212.

The location determining module 206 may be configured to determine the geographical location of a particular user. According to an example embodiment, the geographical location is determined through a GPS receiver installed within the client device 102, data received from the base stations of the cellular network, an IP address obtained from the access point providing cord or wireless connection to the client device 102, or a combination thereof. Those who are skilled in the art can readily understand that any other appropriate way of determining the current location of the client device 102 can be used.

Based on the determination of the geographical location of the client device 102, the user of the client device may be provided with location related information. In one example, the user may be provided with information of nearby lottery dealers. In yet another example, if it is determined that the user lottery ticket is a winning ticket, the user can be provided with information of nearby claim centers. Information of nearby lottery dealers or claim centers may include addresses, contact information, routes, directions, operating time, etc. Information of nearby lottery dealers and claim centers can be stored in the dealers' database 216.

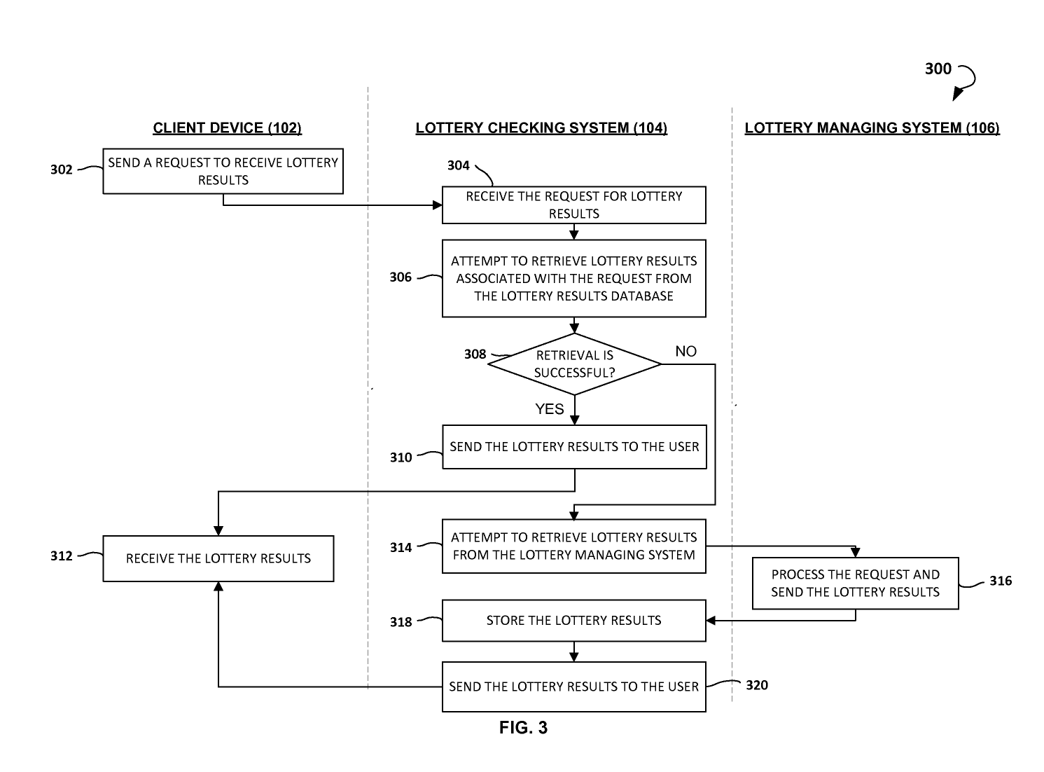

FIG. 3 illustrates a method 300 for delivering lottery results to a user, according to an example embodiment. The method 300 may commence in block 302, where the user sends a request for lottery results via the client device 102 to the lottery checking system 104. Specifically, the user could make a selection to receive results of a desired lottery on a specific drawing date. The selection can be made through the software 110 or the web browser 112 embedded in the client device 102.

After the request for lottery results is sent, it may be received by the lottery checking system 104 (via the communication module 202 or the web server 208) in block 304. In block 306, the checking module 204 may attempt to retrieve the lottery results relative to the selected lottery on the selected drawing date from the lottery results database 214. If the retrieval is successful (block 308), the lottery results may be sent to the client device 102 in block 310. In block 312, the lottery results may be received by the client device 102.

Alternatively, if the lottery results database 214 does not comprise the requested information, in block 314, the checking module 204 may attempt to retrieve the lottery results from the remote lottery managing system 106 associated with the selected lottery. In block 316, the lottery managing system 106 processes the retrieving request of the lottery checking system 104, and sends a corresponding response. The received information may be optionally stored (in block 318) in the lottery results database 214. Finally, in block 320, the lottery results may be delivered to the client device 102.

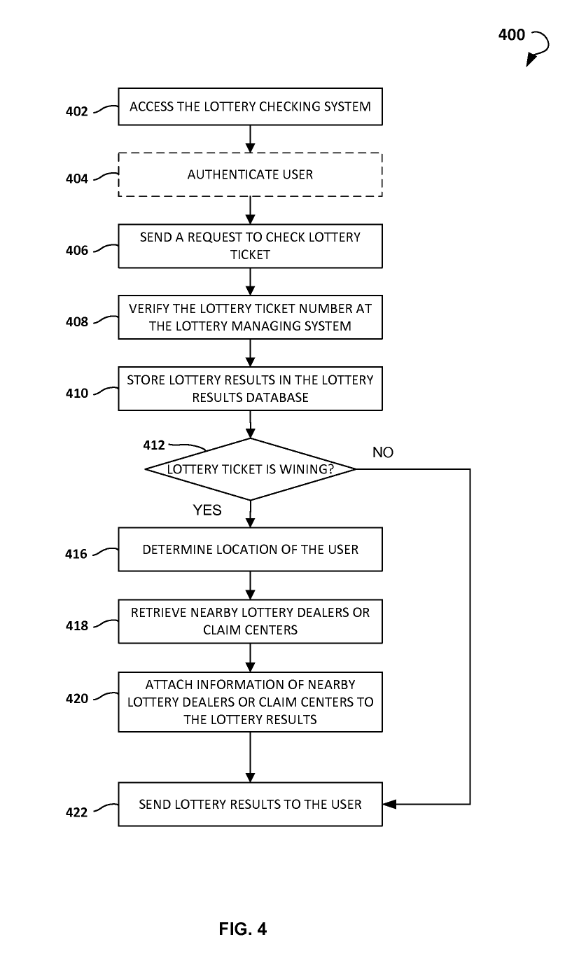

FIG. 4 illustrates a method 400 for checking a lottery ticket, according to an example embodiment. The method 400 may commence in block 402, where the user accesses the lottery checking system 104 via the client device 102 having the dedicated software 110 or the browser 112 embedded therein.

In block 404, the lottery checking system 104 may optionally authenticate the credentials of the user. The authentication can be performed manually, where the user is requested to input membership details (such as a login and password), which are then compared to the data stored in the subscriber database 210. Alternatively, the authentication process can be implemented automatically, where the lottery checking system 104 automatically identifies the user based on service information (e.g., a determined phone number, IP address, and cookies).

In block 406, the user may submit a request to check a lottery ticket in the lottery checking system 104. The request comprises a lottery ticket number as issued by the lottery managing system 106 at the time of its purchase. The user request may be processed by the checking module 204.

Further, in block 408, the checking module 204 may verify the lottery ticket number with the lottery managing system 106, which issued this lottery ticket. The result of verification (i.e., whether the lottery ticket is a winning ticket or losing ticket) is delivered to the checking module 204.

In block 410, the checking module 204 may optionally store the lottery result associated with the user request in the lottery results database 214. If the lottery ticket is a winning ticket, the lottery results information may also include the amount of payoff.

In block 412, it is determined whether or not the lottery ticket is a winning ticket. If it is determined that the lottery ticket is a losing one, the method 400 may proceed to block 422, when the lottery results are delivered to the user's client device 102 via the communication module 202 or the web server 208.

If it is determined that the lottery ticket is a winning ticket, in block 416, the location determining module 206 may optionally determine the geographical location of the client device 102. For this purpose, it may be requested that the client device 102 provide location details defined by a GPS receiver installed within the client device. Alternatively, the location can be determined by IP address, base station operating information, and so forth.

In block 418, details regarding lottery dealers or claim centers that are located near the current location of the user are retrieved from the dealer database 216, as determined in block 416. Further, in block 420, information related to lottery dealers or claim centers is attached to the lottery results. In block 422, the lottery results are delivered to the client device 102 for reviewing.

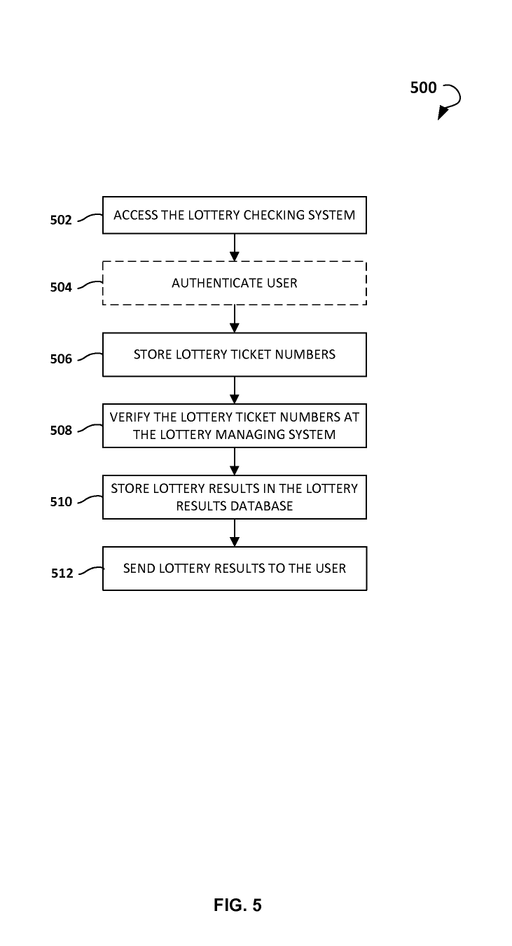

FIG. 5 illustrates a method 500 for checking a lottery ticket, according to another example embodiment. The method 500 may commence in block 502 with the user accessing the lottery checking system 104 via the client device 102 having the dedicated software 110 or the browser 112 embedded therein.

In block 504, the lottery checking system 104 may optionally authenticate the user for accessing. The authentication can be performed manually after the user is requested to input membership details (such as a login and password), which are then compared to the data stored in the subscriber database 210. Alternatively, the authentication process can be implemented automatically when the lottery checking system 104 automatically identifies the user based on service information (e.g., phone number, IP address, and cookies).

In block 506, the user inputs one or more lottery ticket numbers, bar code, serial numbers or other unique ticket identification number that were issued by the corresponding lottery managing system 106 at the time of their purchase at a dealer store. The inputted lottery ticket numbers may be stored in the lottery ticket database 212.

In block 508, when the lottery operating entity holds the lottery to which the stored tickets are associated, the checking module 204 automatically verifies the lottery ticket numbers stored in the lottery ticket database 212 in the corresponding remote lottery managing system 106 to determine whether the lottery tickets are winning or losing tickets.

Further, in block 510, the checking module 204 may store the lottery results associated with the lottery tickets in the lottery results database 214. Finally, in block 512, the checking module 204 may optionally inform the user about the lottery results via an e-mail, an instant message, a SMS, a MMS, or any other suitable communication means.

The user may access his account in the subscriber database 210 and check which lottery tickets are winners and which are losers. The user may also be provided with information regarding nearby lottery dealers or claim centers based on his current location. If one or more of the lottery tickets are winning tickets, the user may be provided with payoff information (e.g., the amount of won monetary prize).

The user may also be provided with information of total payoffs won during a certain period of time and the total amount of total losses.

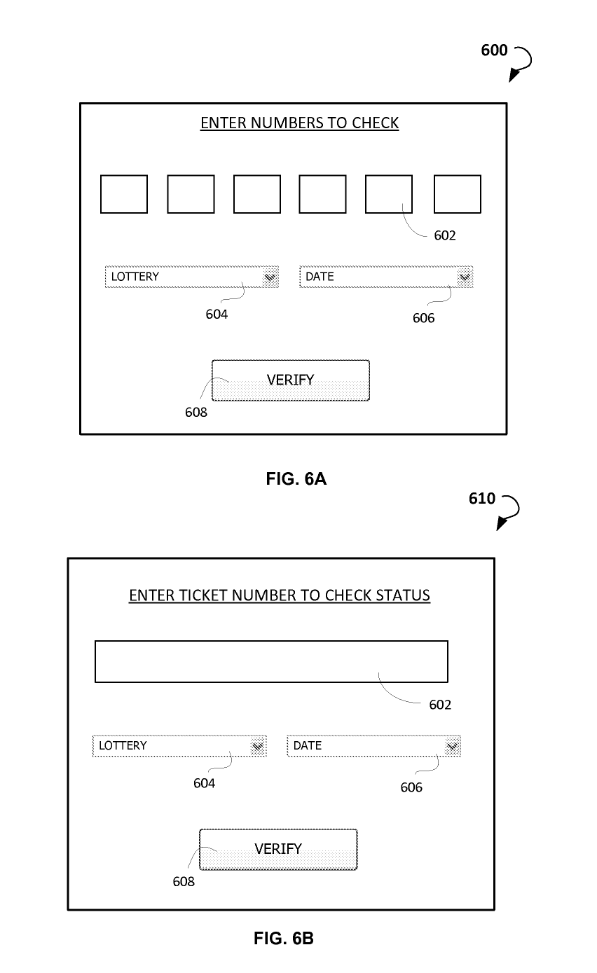

FIG. 6A is a graphical user interface (GUI) 600 displayed within the client device 102, according to an example embodiment. The GUI 600 allows any user to check whether the numbers were winning numbers in a specific lottery held on a specific drawing date.

The GUI 600 may comprise input boxes 602 to input numbers to be checked, a drop-down menu 604 to select a lottery, and a drop-down menu 606 to select a drawing date. The date may not be used when a barcode (or any other unique identification key) associated with the lottery tickets is used to check the results with the lottery management system 108. The GUI 600 may further comprise a user interface control means 608 to submit the inputted data to the lottery checking system 104. The control means 608, when selected by the user, causes a user request to be sent to the lottery checking system 104, as described with reference to FIG. 3.

FIG. 6B is a GUI 610 displayed in the client device 102, according to another example embodiment. The GUI 610 may allow any user to check whether the lottery ticket is a wining or losing ticket within a specific lottery held on a specific drawing date.

The GUI 610 comprises the input box 612 to input a lottery ticket number to be checked, the drop-down menu 604 to select a lottery, the drop-down menu 606 to select a drawing date, and the user interface control means 608 to submit the inputted data to the lottery checking system 104. The control means 608, when selected by the user, causes a user request to be sent to the lottery checking system 104, as described with reference to FIG. 4. The control means 608 can be implemented as a button, icon, selectable link, or another selectable object.

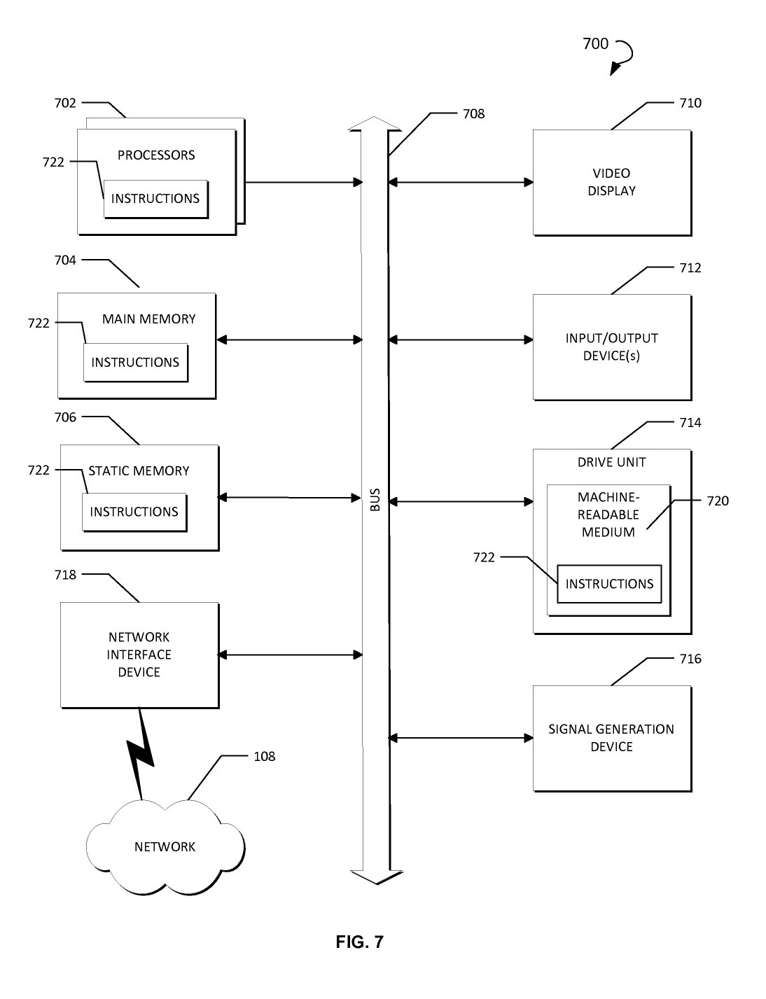

FIG. 7 shows a diagrammatic representation of a computing device for a machine in the example electronic form of a computer system 700, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU) or a graphics processing unit (GPU), or both), and a main memory 704 and a static memory 706, which communicate with each other via a bus 708. The computer system 700 can further include a video display unit 710 (e.g., a liquid crystal display (LCD) or a cathode ray tube (CRT)). The computer system 700 also includes at least one input/output devices 712, such as an alphanumeric input device (e.g., a keyboard), a cursor control device (e.g., a mouse), a microphone, a scanner and so forth. The computer system 700 also includes a disk drive unit 714, a signal generation device 716 (e.g., a speaker), and a network interface device 718.

The disk drive unit 714 includes a computer-readable medium 720, which stores one or more sets of instructions and data structures (e.g., instructions 722) embodying or utilized by any one or more of the methodologies or functions described herein. The instructions 722 can also reside, completely or at least partially, within the main memory 704 and/or within the processors 702 during execution thereof by the computer system 700. The main memory 704 and the processors 702 also constitute machine-readable media.

The instructions 722 can further be transmitted or received over the network 108 via the network interface device 718 utilizing any one of a number of well-known transfer protocols (e.g., Hyper Text Transfer Protocol (HTTP), CAN, Serial, SSL, and Modbus).

While the computer-readable medium 720 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, HyperText Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, the methods for checking lottery tickets and playing lottery have been described. The method provides an effective technique for players to check the status of their lottery tickets in a direct and convenient way without any necessity to browse the Internet or watch TV. The method also minimizes instances of fraud by lottery dealer staff. The method also provides an efficient way to play lottery.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A computer-implemented method for checking winning lottery tickets, the method comprising:
receiving, by a processor, a user request to check a lottery ticket, the user request comprising a ticket number;
verifying, by the processor, the lottery ticket number with a lottery managing system to determine whether the lottery ticket is a winning lottery ticket;
determining, by the processor, that the lottery ticket is the winning ticket;
based on the determination, providing, by a processor, a location of one or more nearby claim centers that is within a predetermined range of the user, wherein the one or more nearby claim centers allow for redemption of the winning ticket; and
providing, by the processor, lottery results to the user.

2. (canceled)

3. The computer-implemented method of claim 1, further comprising retrieving, by the processor, user credentials, the user credentials being used for accessing a lottery checking system.

4. The computer-implemented method of claim 1, wherein the lottery results comprise one or more of the following: information as to whether the lottery ticket is a winning ticket or a losing ticket, winning numbers, a payoff amount, lottery dealers, claim procedure, claim centers, and a claim deadline.

5. The computer-implemented method of claim 1, further comprising receiving, by the processor, a user request to retrieve the results of a desired lottery.

6. The computer-implemented method of claim 1, further comprising:
managing, by the processor, favorite numbers of the user; and
maintaining, by the processor, a record of winning and losing tickets of the user.

7. The computer-implemented method of claim 1, wherein if the lottery ticket is a winning lottery ticket, the lottery results comprise a payoff amount, and the method further comprises:
providing, by the processor, the user with information of the payoff amount; and
providing, by the processor, the user with information of nearby claim centers based on the user location.

8. The computer-implemented method of claim 7, further comprising storing, by the processor, the payoff amount associated with one or more lottery tickets of the user in a database.

9. The computer-implemented method of claim 1, further comprising:
storing, by the processor, one or more lottery tickets in a database, the lottery tickets being associated with the user; and
automatically, by the processor, verifying the stored lottery tickets with the lottery managing system to determine whether or not the lottery tickets are winning lottery tickets.

10. The computer-implemented method of claim 1, wherein the user request to check the lottery ticket comprises game numbers selected by the user; and
wherein verifying the lottery ticket with the lottery managing system to determine whether the lottery ticket is a winning lottery ticket is based on the selected numbers.

11. An apparatus for checking winning lottery tickets, the apparatus comprising:
at least one processor configured to:
receive a user request to check for a lottery ticket, the user request comprising a ticket number;
verify the lottery ticket number with a lottery managing system to determine whether the lottery ticket is a winning lottery ticket;
determine that the lottery ticket is the winning ticket;
based on the determination, provide a location of one or more nearby claim centers that is within a predetermined range of the user, wherein the one or more nearby claim centers allow for redemption of the winning ticket; and
provide lottery results to the user; and
a memory coupled to the at least one processor, the memory comprising codes for the at least one processor.

12. (canceled)

13. The apparatus of claim 11, wherein the at least one processor is further configured to retrieve user credentials, the user credentials being used for accessing a lottery checking system.

14. The apparatus of claim 11, wherein the lottery results comprise one or more of the following: information on whether the lottery ticket is a winning ticket or a losing ticket, winning numbers, a payoff amount, lottery dealers, claim centers, and a claim deadline.

15. The apparatus of claim 11, wherein the at least one processor is further configured to receive a user selection to retrieve the results of a desired lottery.

16. The apparatus of claim 15, wherein the at least one processor is further configured to provide the user with the results of the selected lottery.

17. The apparatus of claim 11, wherein if the lottery ticket is a winning lottery ticket, the lottery results comprise the payoff amount, and the at least one processor is further configured to:
provide the user with information of the payoff amount; and
provide the user with information regarding nearby claim centers based on location of the user.

18. The apparatus of claim 17, wherein the at least one processor is further configured to store the payoff amount associated with one or more lottery tickets of the user in a database.

19. The apparatus of claim 11, wherein the at least one processor is further configured to:
store one or more lottery tickets in a database, the lottery tickets being associated with the user; and
automatically verify the stored lottery tickets with the lottery managing system to determine whether or not the lottery tickets are winning lottery tickets.

20. (canceled)
